(19) United States
(12) Patent Application Publication
(10) Pub. No.: US 2004/0229504 A1
(43) Pub. Date: Nov. 18, 2004

(54) [SIGNAL ADAPTOR]

(75) Inventor: Kun-Hung Liu, Taipei (TW)

Correspondence Address: AI TI YA INDUSTRIAL CO., LTD., 2F-4, NA 148, SEC. 4, CHUNG HSIAO E. ROAD, TAIPEI R.O.C., TW

(73) Assignee: AI TI YA INDUSTRIAL CO., LTD., Tan-Shui Town, Taipei Hsien. (TW)

(21) Appl. No.: 10/707,988

(22) Filed: Jan. 30, 2004

(30) Foreign Application Priority Data
Mar. 4, 2003 (TW) 09220257

(51) Int. Cl. H01R 9/05

(52) U.S. Cl. 439/578

(57) ABSTRACT

A signal adaptor is described. The signal adaptor comprises a fastening member, comprising a buckling portion and a tube extending form from a rear side of said securing member; a nut, for fitting the fastening member; a receiving member having a buckling set formed on an outer contacting portion, for fitting onto the fastening member to tightly fasten the receiving member to the securing portion of the fastening member; and a securing member having a buckling set at an inner contacting portion, wherein when securing member is fitted around the receiving member, said buckling set of the contacting portion of the securing member buckles into the buckling set of the contacting portion of the receiving member for positioning said securing member onto the receiving member.

### CROSS REFERENCE TO RELATED APPLICATIONS

This application claims the priority benefit of Taiwan patent application number 092203257 filed on Mar. 4, 2003.

### BACKGROUND OF INVENTION

1. The Field of the Invention

The present invention relates to a structure of a signal adaptor, and more particularly to a signal adaptor having a receiving member and a securing member comprised of rubber material for fitting on to the receiving member. Because of the elasticity of the securing member, the securing member can securely hold the receiving member.

2. Description of Related Art

Conventional signal adaptor comprises a main body portion for securely buckling a round thin tube, wherein a signal wire is inserted into the thin tube. In order to fix the signal wire into the thin tube, a suitable hand tool is used to press the thin tube onto the outer flange of the thin tube so that it deforms to clamp the signal wires there-within. The elastic force is the only force that clamps and positions the signal wire within the thin tube. The round thin tube has a vertical joint slit which can easily crack during clamping of the signal wire. And once the tube is cracked, the signal wires will come loose due to unwanted external force to cause bad contact of the inner conductor of the signal wire. For improving this defect, some of the manufacturer have proposed use a tubular member and a external tubular member to connect the signal wire with the signal adaptor, wherein an external tubular member rotably fits around over the extended tubular portion of the main body portion and can rotate freely over the extended tubular portion of the main body portion such that a concentric space is formed therebetween. The outer sidewall of the extending portion of the external tubular member is a smooth surface. A tubular member is fitted around the extended distal end of the external tubular member, wherein the tubular member has an awl shaped hole that is designed against the external tubular member while pressing the external tubular member. Meanwhile, the awl shaped hole of the tubular member also presses against the extended distal end portion of the external tubular member causing deformation of the extended distal end portion of the external tubular member to securely fasten the signal wire within the signal adaptor. However, there are some defects in the prior art signal adaptor as described below.

1. The awl shaped hole of the tubular member presses the external tubular member such that external tubular member deforms to fasten the signal wire. However, if the signal wire is bent or gets pulled during assembling, the tubular member gets easily loose and escapes from the external tubular member.

2. Both the tubular member and the external tubular member are made of metal, and therefore the contact surface of both the tubular member and the external tubular member are hard and lack elasticity. Accordingly, they should be assembled very closely to have less friction and such assembly can be troublesome and inconvenient.

3. The tubular member fits around the external tubular member, and accordingly, the dimension of the tubular member has to be larger than the external tubular member, and also should be larger than the signal adaptor as well, thus the tubular member will block the signal adaptor when connecting the signal adaptor to the slot.

Further, another conventional signal adaptor comprises a one-piece securing member to withstand the outward force while tubing head gets deformed into a shape such that the outer flange of the tubing head presses against the inner flange of the securing member to substantially clamp the signal wire and provide water proof effect.

The above conventional design is capable of clamping the signal wire securely as well as provide water proof effect, however, the securing member, the tubular member, the external tubular member, the nut and other elements are all made of metal and having no elasticity and tolerance, and therefore when fitting the signal wire into the tubular member, the shape of the signal wire must be absolutely round. Generally, the signal wire needs to be cut and trimmed before fitting into the tubular member, and the shape of the signal wire will become slightly flat due to cutting or trimming causing difficulty of fitting signal wire into the tubular member. Besides, when the signal wire is bent or twisted while assembling will cause difficulty for fitting the signal wire into the tubular member. Therefore, it is highly desirable to resolve the problems of the conventional signal adaptor.

### SUMMARY OF INVENTION

Accordingly, in the view of the foregoing, the present inventor makes a detailed study of related art to evaluate and consider, and uses years of accumulated experience in this field, and through several experiments, to create a new signal adaptor. The present invention provides an innovated cost effective signal adaptor to overcome the defects of the prior art described above.

According to one aspect of the present invention, the securing member is made of rubber material. The securing member comprises a buckling set positioned on an inner contact surface thereof, and the receiving member comprises a corresponding buckling set on an outer contacting portion thereof such that when the securing member is fitted around the receiving member, the buckling set of the securing member buckles on to the buckling set of the receiving member so that the securing member covers tightly around the receiving member.

According to another aspect of the present invention, because the securing member is comprised of a rubber material, and therefore the elastic property of the securing member allows the securing member to easily fit around the receiving member.

According to another aspect of the present invention, the buckling set of the receiving member comprises a frontal buckling element and a rearbuckling element for positioning the buckling set of the securing member.

### BRIEF DESCRIPTION OF DRAWINGS

For a more complete understanding of the present invention, reference will now be made to the following detailed description of preferred embodiments taken in conjunction with the following accompanying drawings.

FIG. 1 is an elevational view of a signal adaptor according to a preferred embodiment of the present invention.

FIG. 2 is an exploded view of the signal adaptor according to a preferred embodiment of the present invention.

FIG. 3 is a sectional side exploded view of the signal adaptor according to a preferred embodiment of the present invention.

FIG. 4 is a sectional side view of the signal adaptor according to a preferred embodiment of the present invention.

FIG. 5 is a sectional view of the assembly of the signal adaptor and a signal wire according to a preferred embodiment of the present invention.

### DETAILED DESCRIPTION

Reference will be made in detail to the preferred embodiments of the invention, examples of which are illustrated in the accompanying drawings. Wherever possible, the same reference numbers are used in the drawings and the description to refer to the same or like parts.

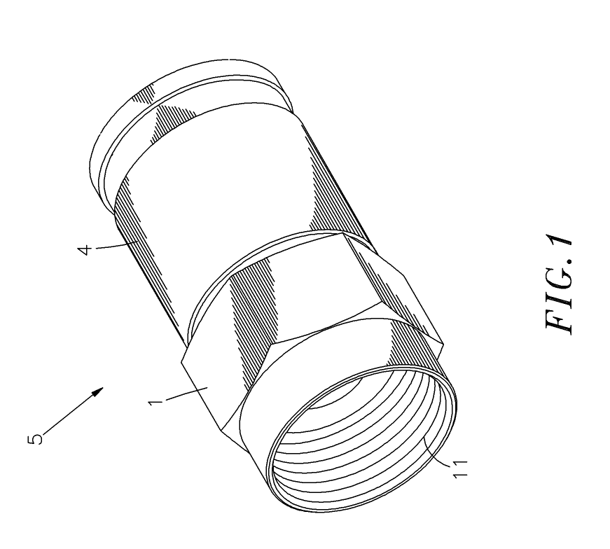

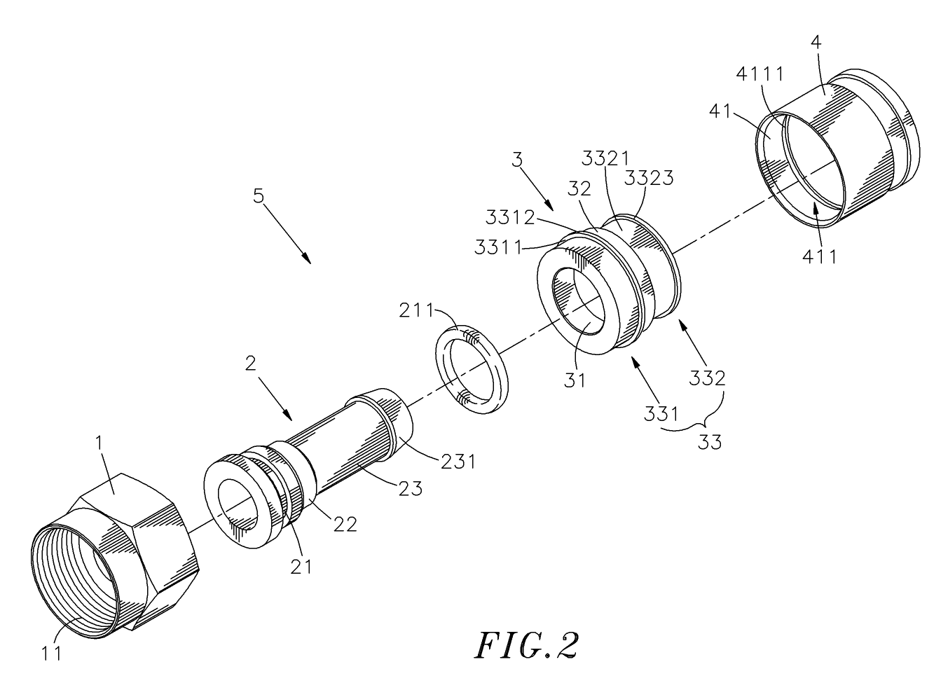

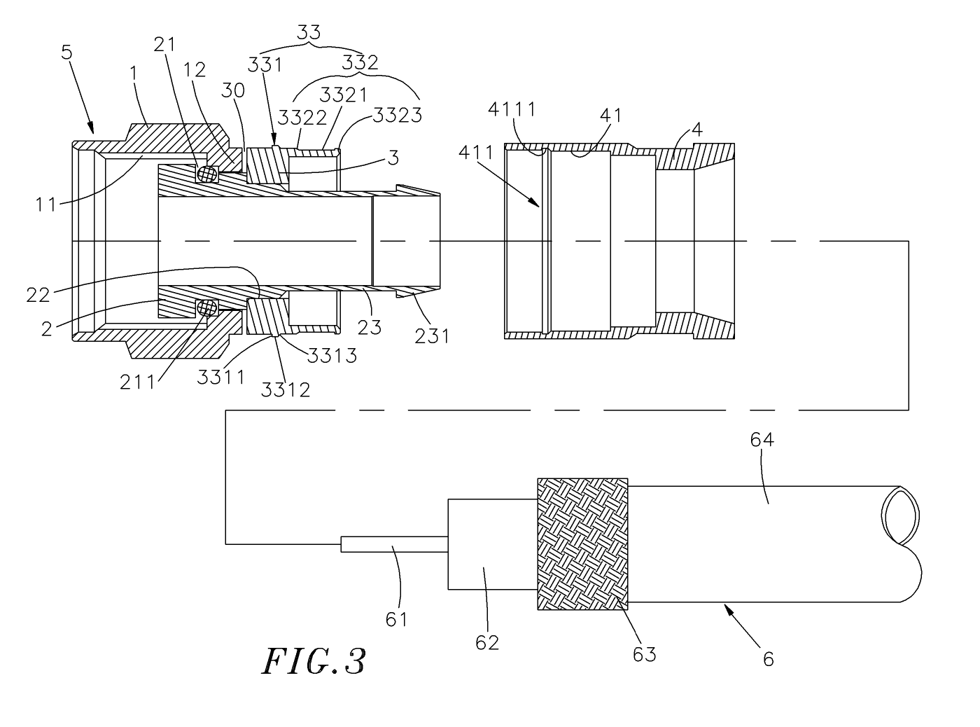

Referring to FIGS. 1, 2 and 3, an elevational view, an exploded view, and a sectional side exploded view of a signal adaptor according to a preferred embodiment of the present invention are shown. The signal adaptor 5 of the present invention comprises a nut 1, a fastening member 2, a receiving member 3 and a securing member 4.

The nut 1 is a hollow element having an inner threaded portion 11, and a jointing portion 12 formed protruded around a lower open-end portion of the nut 1 The fastening member 2 is a hollow tube for fitting into the nut 1. The fastening member 2 comprises a buckling portion 21 formed at a frontal end. A securing element 22 is formed at a backside of the buckling portion 21. A tube 23 is integrally formed extending from the securing element 22, wherein a hooking portion 231 is formed at a distal end thereof and an outer diameter of the hooking portion 231 from the bottom to the top towards its distal end gradually becomes smaller. The buckling portion 21 is for receiving a circular pad 211, wherein the pad 211 and the buckling portion 21 can be within the nut 1 coming in contact with the jointing portion 12 of the nut 1 to securely position the buckling portion 21 of the fastening member 2 within the nut 1.

The receiving member 3 is a sleeve for receiving the fastening member 2, wherein after the fastening member 2 is received within the receiving member 3, a gap 30 is formed between the jointing portion 12 of the nut 1 and an edge portion of the receiving member 3. The receiving element 3 is also a hollow tube comprising a buckling hole 31 at a distal end and buckling set 33 formed on an outer contacting portion 32. The buckling set 33 comprises a frontal buckling element 331 and a rear buckling element 332 positioned on the contacting portion 32. The frontal buckling element 331 has a side formed as a blocking portion 3311, and along the blocking portion 3311 towards rear portion has a top flange 3312 and a slope 3313. The rear buckling element 332 has a groove 3321 and a protrusion 3323, wherein the protrusion 3323 has a leading portion 3322 formed at the outer flange.

The securing member 4 is for receiving the contacting portion 32 covering the receiving member 3. The securing member 4 comprises an inner contacting portion 41 of having buckling set 411. The buckling set 411 comprises an indention 4111 formed around the contacting portion 41 and an outer flange 412 formed at the outer side of the contacting portion 41.

Hereinafter the assembly of the signal adaptor will be described as follows. First, the fastening member 2 is fit into the nut 1 such that the buckling portion 21 of the fastening member 2 is supported against the jointing portion 12 of the nut 1. Next, the receiving member 3 is fit into the fastening member 2 from the rear end such that the buckling hole 31 of the receiving member 3 buckles tightly with the securing portion 22 of the fastening member 2 for securing the receiving member 3 to the fastening member 2. Next, the securing member 4 is fit around the receiving member 3 within the contacting portion 41 of the securing member 4 coming in contact with the contacting portion 32 of the receiving member 3, and the buckling set 411 of the contacting portion 41 buckles with the buckling set 33 of the contacting portion 32, wherein the indentation 4111 of the contacting portion 41 buckles the protrusion 3323 of the rearbuckling element 332 of the buckling set 33, and the outer flange 412 of the contacting portion 41 buckles into the groove 3321 of the buckling set 33. Thus, the securing member 4 can be positioned by the rearbuckling element 332 of the receiving member 3. Thus, the assembly of the signal adaptor 5 is completed.

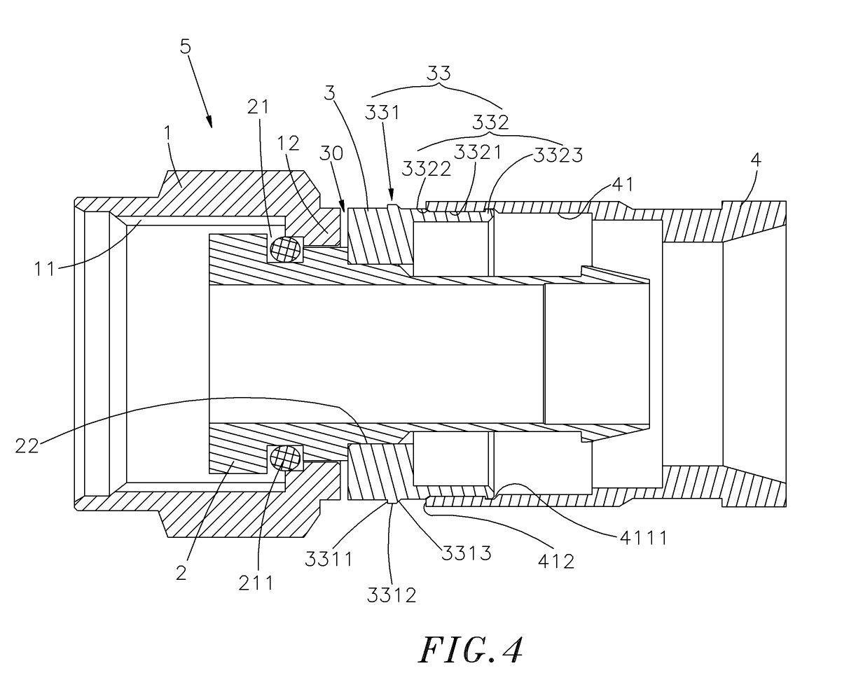

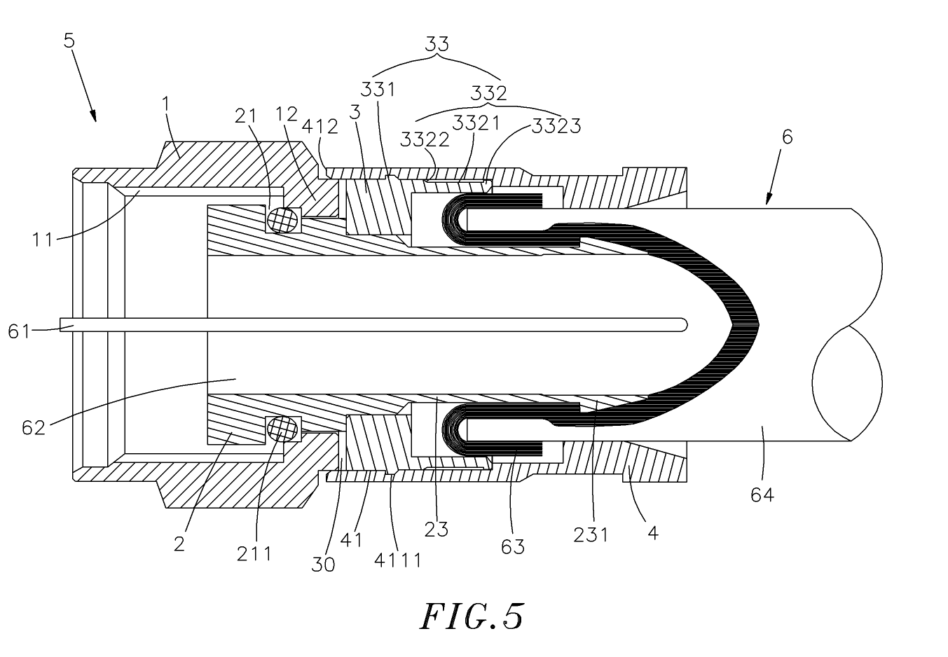

Referring to FIGS. 4 and 5, a sectional side view of the signal adaptor according to preferred embodiment of the present invention and a sectional view of the assembly of the signal adaptor and a signal wire according to a preferred embodiment of the present invention are respectively shown. As shown, a signal wire 6 is fitted from the securing member 4 of the signal adaptor 5, the conductor wire 61 and the isolation tube 62 of the signal wire 6 are secured by the fastening member 2, wherein the isolation tube 62 extends within the hooking portion 231 at the distal end of the fastening member 2 slightly outwards, the metallic layer 63 and the isolation layer 64 of the signal wire 6 extends between the hooking portion 231 and the securing member 4. For fitting the signal wire 6, the signal wire 6 is first inserted into the securing member 4, and then the signal wire 6 together with the securing member 4 is pushed toward the nut 1 such that the outer flange 412 of the securing member 4 is pushed up to the contacting portion 32 along the leading portion 3322 of the groove 3321 passing the contacting portion 32 comes in contact with the slope 3313 of the frontal buckling element 331 until reaching the jointing portion 12 of the nut 1 via the top flange 3312 thus allowing the buckling set 411 of the securing member 4 buckle onto the frontal buckling element 331, and the indentation 4111 of the buckling set 411 to buckle onto the blocking portion 3311 and the top flange 3312 of the frontal buckling element 331, this arrangement will force the securing member 4 to further enlarge the opening for securely fitting the receiving member 3. Meanwhile, the metallic layer 63 and the isolation layer 64 of the signal wire 6 within the securing member 4 run through the receiving member 3 and the metallic layer 63 makes a contact with the receiving member 3. The metallic layer 63 and the isolation layer 64 are forced within the securing member 4 tightly and securely covering the signal wire 6. The hooking portion 231 of the fastening member 2 extends outwardly to push the metallic layer 63 and the isolation layer 64 so that the signal wire 6 is securely positioned inside the signal adaptor 5.

The securing member 4 of the signal adaptor 5 is made from a rubber material, and therefore even when the distal end of the signal wire 6 is not round in shape, the elastic property of the securing member 4 can still allow to push the signal wire 6 and secure the signal wire 6 within the signal adaptor 5 regardless of the shape of the signal wire 6.

Additionally, when the receiving element 3 of the signal adaptor 5 is fitted around the fastening member 2, the gap 30 is maintained between the edge portion of the receiving member 3 and the jointing portion 12 of the nut 1 and thereby preventing the receiving member 3 to come in direct contact with the jointing portion 12 of the nut 1, therefore friction between the receiving member 3 and the nut 1 can be substantially reduced, and the nut 1 can be turned smoothly. Further, because the securing member 4 is made of rubber, its assembly over the receiving member 3 can be easily accomplished.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and nonlimiting sense.

1. A signal adaptor, comprising:
a fastening member, comprising a buckling portion and a tube extending from a rear side of said fastening member;
a nut, for fitting said fastening member;
a receiving member, having a buckling set formed on an outer contacting portion, for fitting onto said fastening member to tightly fasten said receiving member to said securing portion of said fastening member; and
a securing member having a buckling set at an inner contacting portion, wherein when securing member is fitted around said receiving member, said buckling set of said contacting portion of said securing member buckles into said buckling set of said contacting portion of said receiving member for positioning said securing member onto said receiving member.

2. The signal adaptor according to claim 1, wherein said buckling set of said contacting portion of said receiving member comprises a frontal buckling element and a rear buckling element on said contacting portion.

3. The signal adaptor according to claim 2, wherein said frontal buckling element of said buckling set has a side comprising a blocking portion and a top flange and a slope formed along the blocking portion and at a rear side thereof.

4. The signal adaptor according to claim 2, wherein said rear buckling element of said buckling set has a groove and a protrusion.

5. The signal adaptor according to claim 1, wherein when said securing member is fit onto said receiving member, an outer flange of said securing member buckles into said groove of said rear buckling element of said receiving member, and an indentation of said securing member holds said protrusion of said rear buckling element of said receiving member to position said securing member around said rear buckling element of said receiving member.

6. The signal adaptor according to claim 4, wherein when said securing member is fit onto said receiving member, an outer flange of said securing member buckles into said groove of said rear buckling element of said receiving member, and an indentation of said securing member holds said protrusion of said rear buckling element of said receiving member to position said securing member around said rear buckling element of said receiving member.

7. The signal adaptor according to claim 1, wherein said buckling set on said contacting portion of said securing member has an indentation formed on said contacting portion.

8. The signal adaptor according to claim 1, wherein when said receiving member fits around said fastening member, a gap is formed between an edge portion of said receiving member and said nut to prevent a friction there-between.
